(19) United States
(12) Patent Application Publication
(10) Pub. No.: US 2006/0107333 A1
(43) Pub. Date: May 18, 2006

(54) Communication method and system between a recording and/or reproducing device and a remote unit

(76) Inventors: Yang Peng, Shanghai (CN); Declan Patrick Kelly, Eindhoven (NL); Bei Wang, Shanghai (CN); Darwin He, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/525,285

(22) PCT Filed: Aug. 13, 2003
(86) PCT No.: PCT/IB03/03696

§ 371 Date: Sep. 28, 2005

(30) Foreign Application Priority Data
Aug. 21, 2002 (EP) 02292073.0

(51) Int. Cl. H04L 9/32

(52) U.S. Cl. 726/27

(57) ABSTRACT

The present invention relates to a communication system comprising a recording and/or reproducing device (11) able to read a data carrier, and a first remote unit (12) comprising additional data for the data carrier. The recording and/or reproducing device (11) and the first remote unit (12) communicate via a network. The communication system comprises a second remote unit (13) able to authenticate a trusted recording and/or reproducing device, and to make the trusted recording and/or reproducing device access the additional data. A trusted recording and/or reproducing device is able to detect the presence of the data carrier in the recording and/or reproducing device and to authenticate said data carrier.

### FIELD OF THE INVENTION

The present invention relates to a communication method via a network between a recording and/or reproducing device able to read a data carrier, and a first remote unit comprising additional data for the data carrier.

This invention is particularly relevant for communication of data between a DVD video player and a web site via the Internet network.

### BACKGROUND OF TH INVENTION

The DVD Forum has established a working group AH1-12 to standardize web-connected DVD, as an extension of the current DVD video specification. The principle is that a DVD video disc in accordance with the new specification will be published with links to the publisher's web sites that contain additional data directly related to said specific DVD video disc. The web site can include, for example, new navigation menus, which can be downloaded and used by a DVD video player containing the DVD video disc instead of original menus. The communication between the DVD player and the web site must satisfy the requirements of the movie studios, which are the following:
Additional data cannot be accessed unless the DVD video disc is present in the DVD player.
The additional data cannot be accessed after the DVD disc has been removed from the DVD player.
   For that purpose, some parts of the additional data on the web site are encrypted to ensure that the DVD video disc is present in the DVD player, as only the DVD disc owners can access said additional data. When a DVD player requests the additional data, the publisher's web site has to perform the steps of detecting the presence of a DVD disc in the DVD player and of authenticating said DVD disc. Then, said DVD player must carry out a step of decrypting the encrypted part of the additional data through the use of a decryption key sent by the web site if an authenticated disc is present in the player. The decryption key is either a random number generated at each user's request, or a portion of raw data located on the DVD disc.

These steps may slow down the performance of the DVD player. They also require extra encryption and decryption modules for the web site and the DVD player, respectively.

### SUMMARY OF THE INVENTION

It is an object of the invention to provide a communication method that improves the performance of the recording and/or reproducing device.

To this end, the communication method in accordance with the invention comprises the steps of:
detecting the presence of the data carrier in the recording and/or reproducing device and authenticating said data carrier, said steps being performed by a trusted recording and/or reproducing device,
authenticating the trusted recording and/or reproducing device, said step being performed by a second remote unit and being able to make the trusted recording and/or reproducing device access the additional data.

As a consequence, the communication method in accordance with the invention is simplified, as it only needs to verify that the recording and/or reproducing device is recognized as trusted before sending the additional data. Such a trusted recording and/or reproducing device is adapted to authenticate the data carrier it contains, which is unlike the prior art where the first remote unit was in charge of said authentication. Therefore, said first remote unit will send to the recording and/or reproducing device, either a decryption key for decrypting the encrypted part of the additional data, said key being valid for a whole session, unlike the prior art where the key was valid only for one request, or decrypted additional data. It results in a better communication between the first remote unit and the recording and/or reproducing device and to a better performance of said device.

The present invention also relates to a communication system comprising a recording and/or reproducing device able to read a data carrier, a first remote unit comprising additional data for the data carrier, and a second remote unit able to authenticate a trusted recording and/or reproducing device, said device and said units communicating via a network.

It finally relates to a remote unit able to authenticate a trusted recording and/or reproducing device and a recording and/or reproducing device comprised in said communication system.

These and other aspects of the invention will be apparent from and elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram representing the communication system in accordance with a first embodiment of the invention,

FIG. 2 is a block diagram representing the communication system in accordance with a second embodiment of the invention,

FIG. 3 is a block diagram representing the communication system in accordance with a third embodiment of the invention, and

FIG. 4 is a block diagram representing the communication system in accordance with a fourth embodiment of the invention.

### DETAILED DESCRIPTION OF THE INVENTION

The present invention relates to a method of communicating data between a recording and/or reproducing device and a remote unit connected to each other via a network.

From a general point of view, the present invention relates to client/server architecture. On the client side, the recording and/or reproducing device is, for example, a home DVD player or a personal computer DVD player with an Internet connection and protocol stack built into it, or a GPRS (General Packet Radio Service) or a third generation mobile phone equipped with Small Format Factor Optical SFFO discs. On the server side, the remote unit is a computer system having web related services or proxies running on it. The network that connects both sides is any kind of network based on TCP/IP protocol (Transmission Control Protocol/Internet Protocol), for example IPv4 or IPv6 protocol.

More particularly, in the following description, the recording and/or reproducing device is a DVD video player, the remote unit is a web site and the network is the Internet.

The communication system in accordance with the invention thus comprises a DVD video player able to read a data carrier, and a web site comprising additional data for the data carrier. In our example, the data carrier is a DVD video disc but it will be apparent to a person skilled in the art that the present invention is not limited to DVD discs. The scope of the present invention generally includes any medium having any physical disc format (e.g. CD, DVD, Blu-ray disc, etc.), including Read Only, Recordable, and Rewritable discs. The present invention generally applies to discs that include different application formats (e.g. video, audio, games, etc.).

A publisher is responsible for managing the web site from inputs of a disc provider, the publisher and the provider being the same person or different persons.

The DVD video disc contains links to the publisher's web sites. When such a disc is inserted into the DVD video player, customers can combine local DVD video with the additional data, which are Internet enhanced content directly related to this specific DVD video disc. The Internet enhanced content is, for example, a new version of DVD menus, pictures, audio or subtitles synchronized with local DVD-Video. DVD disc providers create the Internet enhanced content. The Internet enhanced content is also called enhanced navigation (ENAV) content.

The present invention is based on the fact that the DVD player is trusted, that is to say that said player is able to detect the presence of a DVD disc in the drive unit of the DVD player and to authenticate said disc, i.e. to judge whether the disc is a legal copy or not. The disc detection and authentication can be achieved through the use of a process well known to a person skilled in the art. For example, the DVD player can check whether the table of contents TOC is changed or cleared during one session to detect the presence of the DVD disc. For the DVD disc authentication, the DVD player can use dedicated replication disc stampers and/or the Burst Cutting Area BCA.

According to the invention, the DVD player can check the disc presence for the publisher's web site so it could be trusted by said web site. The web site does not need to do encryption to ensure that the DVD disc is present, but an authentication between the DVD player and the web site is sufficient in order to identify the player and to verify that said player is a trusted one in order to send the additional data from the publisher's web site directly to the trusted DVD player.

If the DVD player is a non-trusted DVD player, the publisher's web site will not allow the decrypted additional data to be accessed directly. This will make the performance of the non-trusted DVD player much poorer than that of a trusted DVD player. In effect, a non-trusted player will need all the necessary steps of authentication and decryption while a trusted player can skip part of these steps.

If the DVD disc inserted in a non-trusted DVD player is a non-authenticated one, the publisher's web site will send either encrypted additional data without the decryption key or no additional data at all to said device.

For the purpose of the invention, it must be possible to perform authentication between almost any manufacturer's player and almost any publisher's web site. There are a number of ways to carry out this authentication procedure.

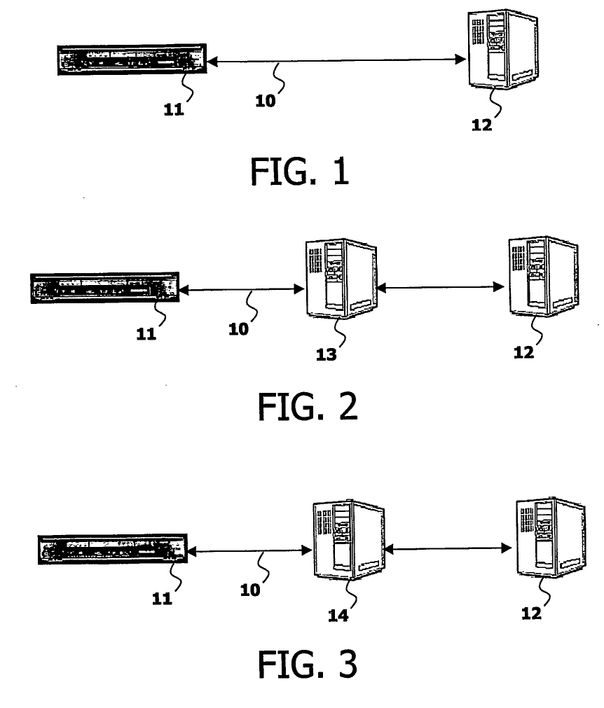

In a first embodiment of the invention depicted in FIG. 1, the communication system in accordance with the invention allows a direct authentication (10) between the DVD player (11) and the publisher's web site (12).

Said first embodiment requires that every publisher of DVD video discs is able to authenticate every manufacturer's player.

In a second embodiment of the invention depicted in FIG. 2, the communication system in accordance with the invention allows an authentication via the manufacturer's web site.

The DVD player (11) is connected to the manufacturer's web site (13) for the authentication procedure (10). The result of the authentication procedure is sent to the publisher's web site (12), which in return sends or does not send the additional data to the DVD player (12). This second embodiment requires that each publisher of DVD video discs is connected to every manufacturer.

In a third embodiment of the invention depicted in FIG. 3, the communication system in accordance with the invention allows an authentication via a web site common to all publishers, for example maintained by the DVD-Forum.

The DVD player (11) is connected to the DVD-Forum web site (14) for the authentication procedure (10). The result of the authentication procedure is sent to the publisher's web site (12), which in return sends or does not send the additional data to the DVD player (11). This third embodiment requires that the common web site is adapted to authenticate every manufacturer's players.

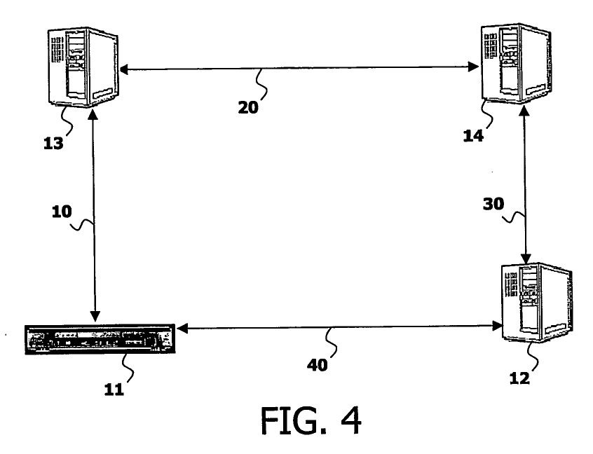

In a fourth embodiment of the invention corresponding to the preferred embodiment and depicted in FIG. 4, the communication system in accordance with the invention allows an authentication via the manufacturer's web site and the web site common to all publishers.

The manufacturer's web site (13) authenticates (10) that the DVD player is one of its players. The result of the authentication procedure is sent to the DVD-Forum web site (14). The DVD-Forum web site (14) has a connection to each of the disc publisher's web sites (12) and each of the manufacturer's web sites (13).

The communication method in accordance with the fourth embodiment is described in more detail hereinafter. The first three embodiments are not described in great detail but can be derived easily from this description by a person skilled in the art.

The communication method in accordance with said fourth embodiment comprises the followings steps:
The DVD player (11) connects to the manufacturer's web site (13).
The manufacturer web site (13) authenticates that said player (11) is one of its players.
After authentication (10), the DVD player (11) sends a request containing the Uniform Resource Locator URL of the web site it wants to access, to the manufacturer's web site (13).
The manufacturer's web site (13) connects to the DVD-Forum web site (14) and indicates the web site it wishes to access. The communication link (20) is secure. For example, when a manufacturer licenses the standard, he can also be assigned a key for this communication link.
The DVD-Forum web site (14) accesses the web site of the publisher (12) and requests an identifier Id and a key K for communication between the DVD player (11) and the publisher's web site (12). The communication link (30) between the DVD-Forum (14) and the publisher's web site (12) is secure and is established, for example, when the publisher licenses the standard.
The DVD-Forum web site (14) returns the key K and identifier Id to the manufacturer's web site (13).
The manufacturer's web site (13) returns the identifier Id and the key K to the DVD player (11). As the authentication between the DVD player (11) and the manufacturer's web site (13) requires a shared secret, this can be used to generate a key enabling a secure communication between said player and said web site.
The DVD player (11) can then communicate (40) directly and securely with the publisher's web site (12) using the key K and the identifier Id and thus access the additional data corresponding to the legal DVD disc inserted in its drive unit.

The reason for having an identifier Id and a key K is to allow different keys to be used for each session, although this is not necessary.

The authentication procedure is based on well known techniques for securely authenticating devices. For example, mobile phone networks such as GSM are able to authenticate individual subscribers even though there are a large number of subscribers. Such an authentication process is depicted in “an Introduction to GSM”, S. M. Redl, M. K Weber, M. W. Oliphant, Artech House Publishers, 1995, Pages 45-46. A similar system can be used in the present communication system, which would also allow revoking of recording and/or reproducing devices, for example in case of theft.

Of the four embodiments described, the fourth embodiment is the one that is most advantageous to implement for the following reasons:
Each manufacturer is responsible for the authentication of their own players.
A common web site, for example the DVD-Forum web site, is central to the authentication procedure, said web site being also responsible for licensing the standard. Therefore it is easy to link the authentication to the licensing of the standard.
Each manufacturer has only a single connection to the DVD-Forum web site and does not need to know about every publisher.
Each publisher has only a single connection to the DVD-Forum web site and does not need to know about every manufacturer.

But the first three embodiments are faster than the fourth embodiment as they do not require two intermediate web sites to perform the authentication of the DVD player.

Moreover, the third embodiment has an advantage in terms of license collection because the DVD-Forum web site can track the devices from the manufacturer individually and hence can check that the number of available devices from a manufacturer does not exceed the number for which licenses have been paid.

Any reference sign in the following claims should not be construed as limiting the claim. It will be obvious that the use of the verb “to comprise” and its conjugations does not exclude the presence of any other steps or elements besides those defined in any claim. The word “a” or “an” preceding an element or step does not exclude the presence of a plurality of such elements or steps.

1. A communication method via a network between a recording and/or reproducing device (11) able to read a data carrier, and a first remote unit (12) comprising additional data for the data carrier, said method comprising the steps of:
detecting the presence of the data carrier in the recording and/or reproducing device and authenticating said data carrier, said steps being performed by a trusted recording and/or reproducing device,
authenticating a trusted recording and/or reproducing device, said step being performed by a second remote unit and being able to make the trusted recording and/or reproducing device access the additional data.

2. A communication system comprising a recording and/or reproducing device (11) able to read a data carrier, a first remote unit (12) comprising additional data for the data carrier, and a second remote unit able to authenticate a trusted recording and/or reproducing device and to make the trusted recording and/or reproducing device access the additional data, a trusted recording and/or reproducing device being able to detect the presence of the data carrier in the recording and/or reproducing device and to authenticate said data carrier, said device (11) and units communicating via a network.

3. A communication system as claimed in claim 2, which comprises a third remote unit (14) and wherein the second remote unit (13) is managed by a manufacturer of recording and/or reproducing devices (11), said third remote unit (14) communicating directly with second remote units (13) and with first remote units (12) via the network.

4. A communication system as claimed in claim 2, wherein the second remote unit is adapted to communicate directly with recording and/or reproducing devices (11) and with first remote units (12) via the network.

5. A communication system as claimed in claim 2, wherein the second remote unit and the first remote unit are the same entity.

6. A remote unit for communicating with a recording and/or reproducing device (11) able to read a data carrier, the remote unit comprising:
means for authenticating a trusted recording and/or reproducing device, a trusted recording and/or reproducing device being able to detect the presence of the data carrier in the recording and/or reproducing device and to authenticate said data carrier, and
means for enabling the trusted recording and/or reproducing device to access additional data corresponding to the data carrier.

7. A recording and/or reproducing device (11) able to read a data carrier, to communicate with a first remote unit (12) comprising additional data for the data carrier, and to communicate with a second remote unit able to authenticate the recording and/or reproducing device, said device comprising means for detecting the presence of the data carrier in the recording and/or reproducing device and means for authenticating said data carrier.
